(19) United States
(12) Patent Application Publication
(10) Pub. No.: US 2004/0093863 A1
(43) Pub. Date: May 20, 2004

(54) Hydraulic buoyant force engine

(76) Inventor: Jian-Hua Huang, Sanchung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/298,092

(22) Filed: Nov. 18, 2002

(51) Int. Cl. F03C 1/00

(52) U.S. Cl. 60/495; 60/496

(57) ABSTRACT

A hydraulic buoyant force engine is composed of a track assembly and several expansion floats. The track assembly contains two track ways forming into V structure. Two transmission chains are equipped at the outer side of each track way to carry the expansion floats. When this apparatus is immersed in a water tank filled with water, the float located at the widely apart portion between the two track ways is expanded to fill with the air such the it floats up and causes the chains to move. As soon as the expanded float approaches the narrowly apart portion between the two track ways, it is squeezed by the track ways to release the air inside and is flattened to sink down along with the movement of chains. By such a continuous motion the mechanical power is produced.

### BACKGROUND OF THE INVENTION

1. Field of the Invention

The present invention relates to hydraulic buoyant force engin, in particular, to a mechanism which is capable of generating a mechanical driving power by circulation of several expansion floats sinking down in the water or floating up on the water level by discharging or absorbing the air.

2. Description of the Prior Art

The conventional power generation techniques such as utilization of water power, steam, power or even neuclear power rely on natural resources of earth. In view of rapid fading of natural resources, and loosing of ecological balance, unlimited and environment unconscious exploitation of natural resources must be haulted for the sake of human right of existence. Development of some sorts of low cost and clean power generation means seems a matter of great urgency.

It is what the reason the inventor has endeavored for years by continuous research and experimentation attempting to find out an ingenious and clean environment conscious power generating technique, and finally has come out with the hydraulic buoyant force engine of the present invention.

### SUMMARY OF THE INVENTION

It is an object of the present invention to provide a hydraulic buoyant force engine which can generate mechanical power without consuming any other resources.

It is another object of the present invention to provide a hydraulic buoyant force engine which can be fabricated with a low production cost and operate with inexpensive hydraulic buoyant force.

To achieve the above objects, the hydraulic buoyant force engine is essentially composed of a track assembly and several expansion floats. The track assembly contains two gourd shaped track ways forming in V shaped structure. Two transmission chains circulation railways are provided to the outer side thereof on which the expansion floats are attached in equal spacing along the chains. The air gate of each float is communicated in series with a connecting hose whose output terminal is communicated with an air conducting tube laid on top side of the track assembly for absorbing or discharging the air. When the track assembly is set in a water tank filled with water, the air conducting tube emerges out of the water surface, the expansion float located at the widely apart portion between the two gourd shaped track ways is expanded by ingress of the air such that the buoyancy of the float overcomes its own weight. As a result, the float rises upward along the track ways and causes the chains to move. As soon as the expanded float approaches the narrowly apart portion between the two track ways, it is squeezed by the track ways to release the air inside and sinks downward along with the movement of the chains due to loosing of its buoyancy. In this way the chains at both sides of the track assembly keep continuous circulation and the mechanical power is outputted from the output shafts of the chains.

### BRIEF DESCRIPTION OF THE DRAWINGS

For fuller understanding of the nature and objects of the invention, reference should me made to the following detailed description taken in conjunction with the accompanying drawings in which:

FIG. 1A is an exploded view illustrating construction of an expansion float of the present invention;

FIG. 1B is an assembled three dimensional view of an expansion float of the present invention;

FIG 2 is a schematic view showing the transmission mechanism of the present invention;

FIG. 3 is a front view of the present invention;

FIG. 4 is a rear view of the present invention;

FIG. 5 is a side view of the present invention; and

FIGS. 6A. 6B are the illustrative views showing operation of the present invention.

### DETAILED DESCRIPTION OF THE PREFERRED EMBODIMENT

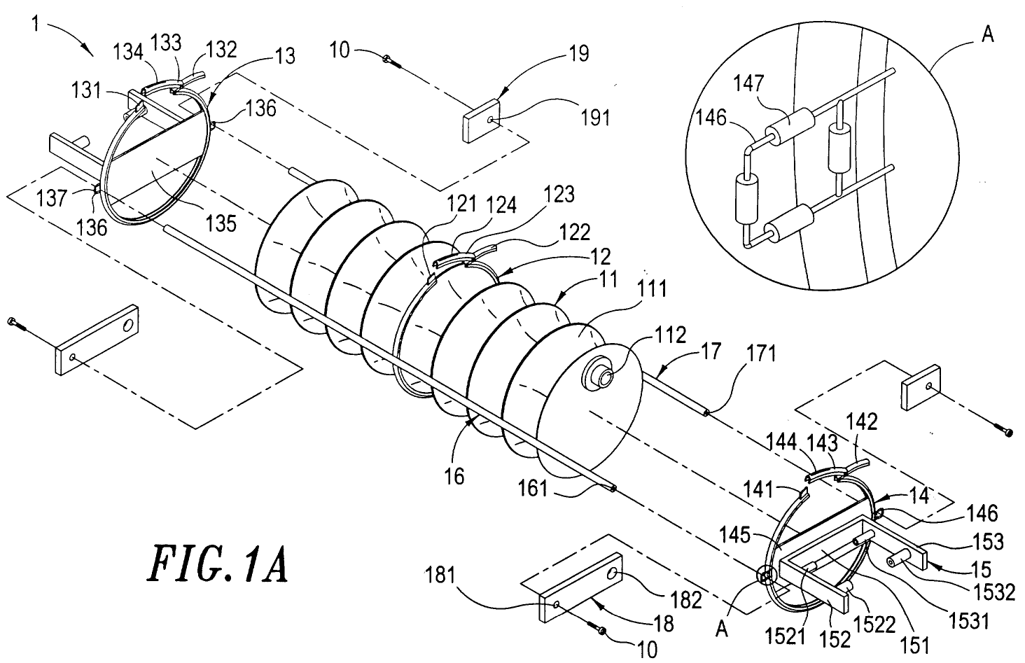

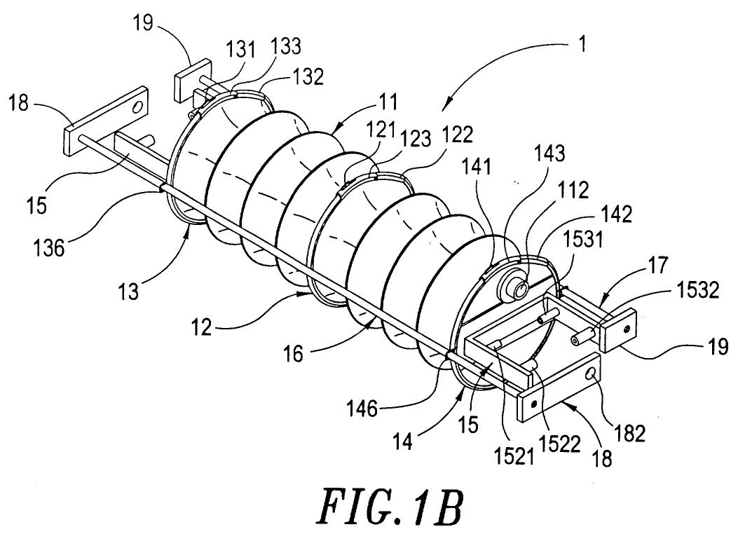

Referring to FIGS. 1A and 1B, an expansion float 1 of the hydraulic buoyant float force engine of the present invention comprises:

a float body 11 made of a steel wire coiled spring (not shown) covered with a canvas 111 so as to assure watertight effect and expansibity. An air gate 112 is provided at one end thereof.

A first hoop 12, a second hoop 13, and a third hoop 14 respectively embrace around middle portion, left, and right sides of the float body 11. Three stoppers 121, 131, 141 are provided at one end of the hoops 12, 13, 14 respectively, while other ends thereof are locked on the hooks 122, 132, 142 respectively. The hooks 122, 132, 142 are engaged to hasps 123, 133, 143 respectively. Tapped holes 124, 134, 144 formed on the hasps 123, 133, 143 respectively are to be fitted to the corresponding stoppers 121, 131, 141 so as to tie up the hasps 123, 133, 134 with the corresponding stoppers 121, 131, 141 by pressing down the hooks 122, 132, 142. The second and third hoops 13, 14 are engaged with guide vanes 135, 145 respectively, and both sides of the hoops 13, 14 are protected by braces 136, 146 respectively. Two braces 136, 146 are provided with Reels 134, 147 respectively.

A supporting stand 15 including a supporting plate 151 is provided at the right end of the float body 11 thereof. Two parallel slide arms 152, 153 are formed at both sides of the supporting plate 151. The inner surfaces of the arms 152, 153 have corresponding in position but different sized first reels 1521, 1531 and second reels 1522, 1532. With this structure the supporting plate 151 can be engaged with two guide vanes 135, 145 of the second and third hoops 13, 14 so as to tighten the supporting stand 15 firmly with the second and third hoops 13, 14.

A first and a second guide bars 16, 17 whose central portions are respectly engaged with two sides of the first hoop 12 so that the two guide bars 16, 17 are engaged respectively with the front and rear sides of the float body 11, and their both ends perforate the braces 136, 146 laid at both sides of the second and third hoops 13, 14 such that the float body 11 may expand or shrink along the first and second guide bars 16, 17, this expansion/shrinking motion of the float body 11 is facilitated by the aid of the reels 137, 147 provided at the sides of the braces 136, 146. The guide bars 16, 17 are hollow and have inner threads 161, 171.

Two joint plates each with two tapped holes 181, 182 (see FIG. 1) are provided. The two joint plates 18 are jointed to both ends of the first guide bar 16 and engaged with screws 10 by aligning the tapped holes 181, 182 with both ends of the first guide bar 16.

Two sliding block 19 each provided with a tapped hole 191 respectively engaged with screw 10 to each end of the second guide bar 17 by aligning the hole 191 with the ends of the second guide bar 17.

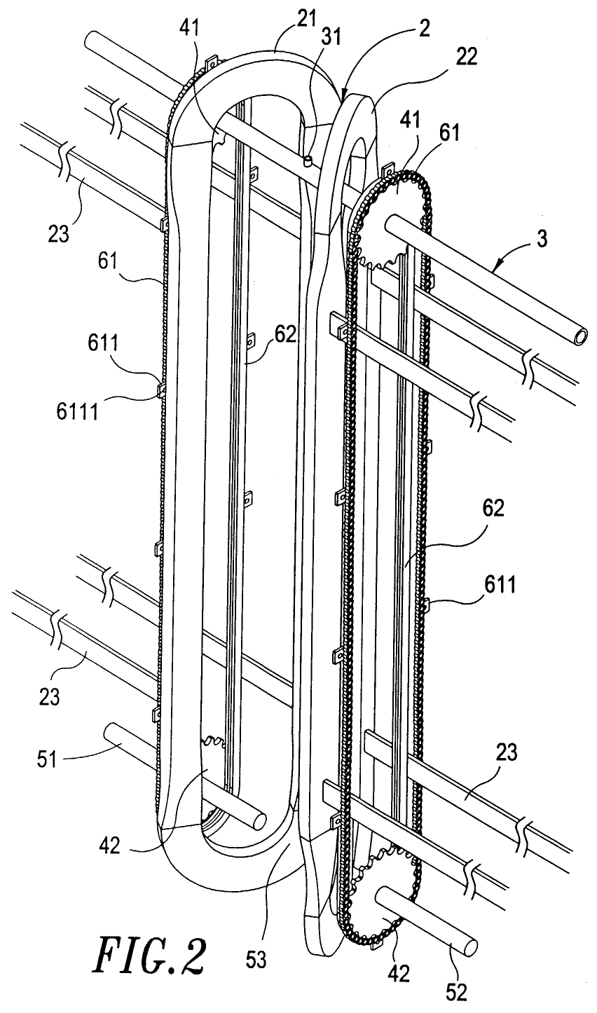

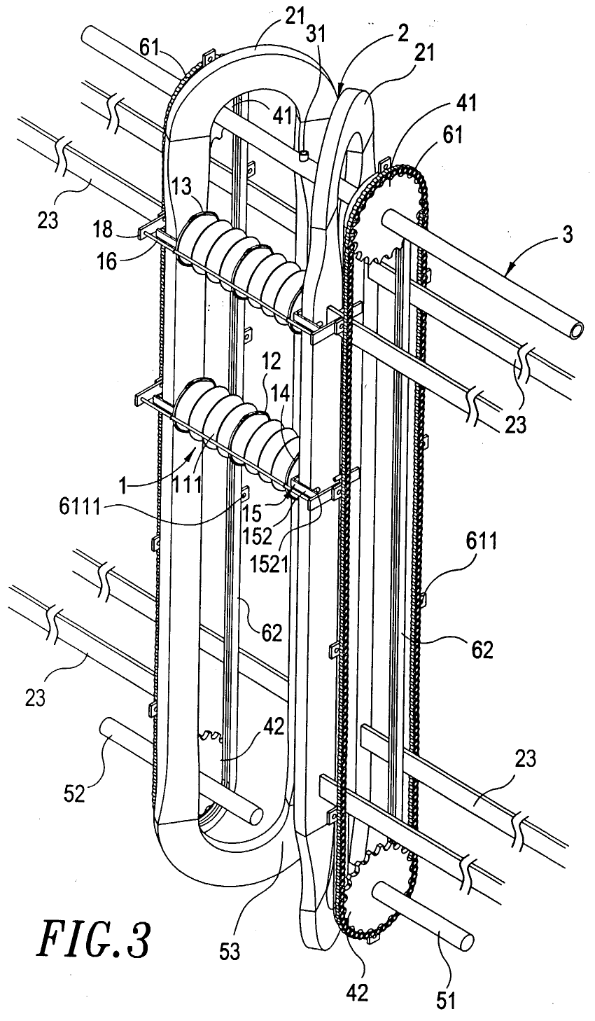

Referring to FIG. 2, the drawing shows the schematic view of the transmission mechanism of the present invention. The transmission mechanism includes a track assembly 2, an air conducting tube 3, two output shafts 51, 52, two chains 61, and two circulation railways 62.

The track assembly 2 is composed of two gourd shaped track ways 21, 22 forming in V shaped structure, and are secured by a framework 23.

The air conducting tube 3 has an air gate 31 at its proper position thereof. The air conducting tube 3 is perforating near the top portion of the track assembly 2 and emerges its both ends out of the track assembly 2. There is a pair of sprockets 41 with each sprocket fitted to one end of the air conducting tube 3 firmly from outside of the track assembly 2.

The two output shafts 51, 52 are each coupled with the corresponding one of the second sprockets 42 by perforating themselves through bottom portion of the two trackways 21, 22, thereafter the two first and the two second sprockets 41, 42 are respectively aligned with each other thereby remaining a disconnected section 55 between the two output shafts 51, 52.

The two chains 61 are each provided with at least one support strap 611 with tapped hole 6111. Each of the two chains 61 is coupled with a pair of first and second sprockets 41, 42 therefore both outersides of the track assembly 2 are enseized by the chains 61.

Each of the two circulation railways 62 are respectively welded to the framework 23 at both sides of the track assembly 2 so as to secure each circulation railway 62 firmly between the track assembly 2 and the chain 61:

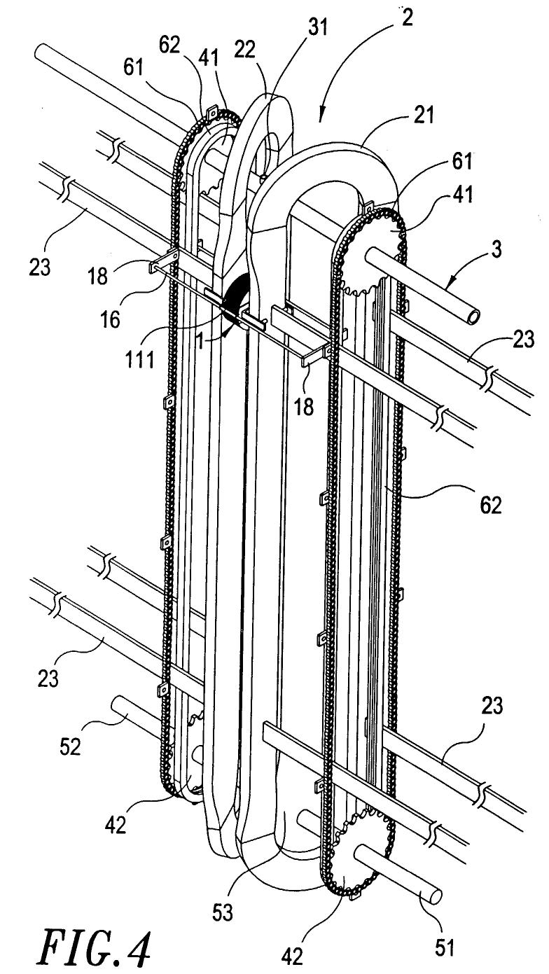

Referring to FIGS. 3 and 4, it is observed from these two drawings that the joint plates 18 fixed to both sides of the float body 11 are respectively engaged to the support straps 611. By aligning tapped holes 182 of the joint plates 18 with tapped holes 6111 of the support straps 611, the joint plates 18 can be engaged firmly with the chains 61 by tightening screws or welding so as to set the float body 11 between the two track ways 21, 22 and the two track ways 21, 22 are laid between the first reels 1521, 1531 and the second reels 1522, 1532 of the stand 15 to let the float body 11 circulate along the tack ways 21, 22.

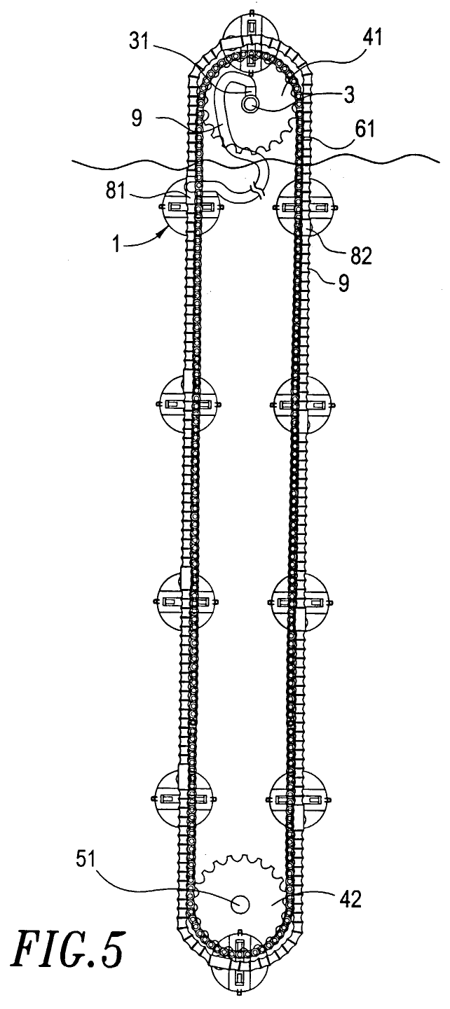

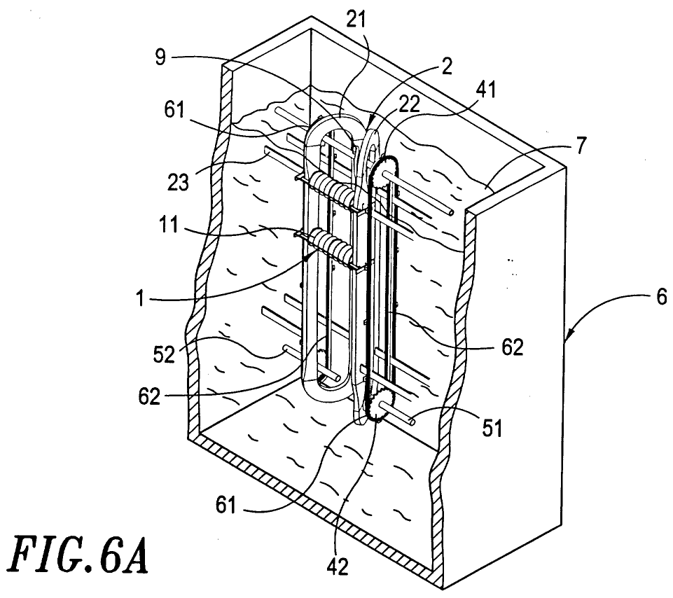

Referring to FIG. 5, in this side view of the present invention, several expansion floats 1 are disposed between the chains 61. One of the floats 1 has a four way coupling 81 jointed to its air gate 112, while the rest of the floats 1 are each provided with a three way coupling 82. All the air gates 112 are linked together with a hose 9 so that all expansion floats 1 can be communicated with one another. Finally, the output terminal of the hose 9 is connected to the air conducting tube 3 via four way coupling such that the air can freely flow into or discharge out of the expansion floats via the air tube 3. The hose 9 disposed in the disconnected section 53 between the output shafts 51 and 52 at the bottom portion of the track assembly 2 is for preventing the hose 9 from entangling with the nearby objects during movement of the float 1.

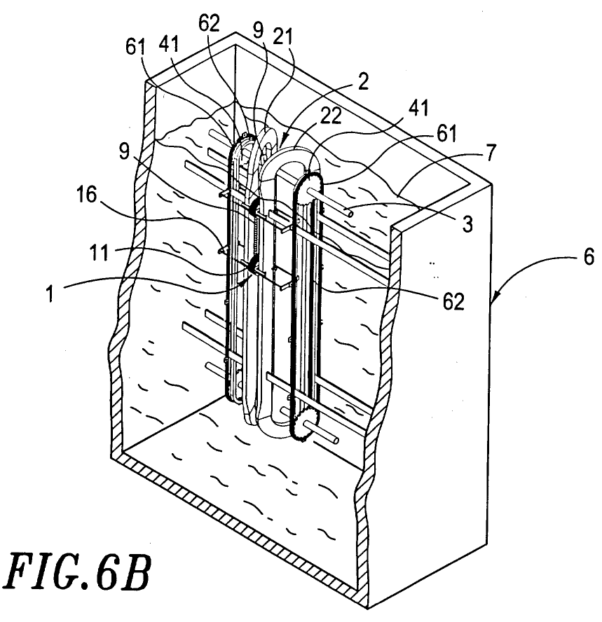

For understanding the operation of the present invention, reference should be made to FIGS. 6A and 6B. Before operation, the framework 23 of the track assembly 2 is fixed in a water tank 6 to hold the track assembly 2 stationary at its position, and emerg the air conducting tube 3 out of the water level 7 so as to communicate with the outside air. When the expansion float 1 sinks under the water level 7 as shown in FIG. 6a, the expansion float 1 located at the widely apart portion between the track ways 21, 22 is expansible to let the air in via the tube 3 so as to build up a buoyant force able to overcome its own weight and floats up. At this moment, being activated by the buoyant force of the expansion float 1, the chains 61 start circulation which in turn activate other expansion floats 1, the first sprockets 41, the air conducting tube 3, the second sprockets 42, and the output shafts 51, 52 to operate. Since the two track way 21, 22 are located between the first reels 1521, 1531 and the second reels 1522, 1532 of the supporting stand 15, this causes the float 1 can move along the two circulation railways with the sliding blocks 9 at its two sides thereof, and the hose 9 connected to the air gate 112 at one side of the float 1 is crooked around the tube 3 as shown in FIG. 5. As soon as the expanded float 1 has passed over the top portion of the track assembly 2 and reached down the narrowly apart portion between the track ways 21 and 22, the hose 9 is straightened as shown in FIG. 6B. The expanded float 1 is now gradually squeezed between the first and the second guide bars 16, 17 to release the air contained inside. The flattened float 1 now sinks down in the water together with the chains 61 by its own weight. Each expansion float 1 carries out this motion one after another along the track assembly 2, and the chains 61 continue to drive the output shafts 51, 52 thereby producing a useful mechanical power.

It is understood from the description of the above example that the invention has several noteworthy advantages, in particular:

1. No costly resources are needed to operate the engine of the present invention, hydraulic buoyant force is freely obtainable.

2. The engine of the present invention can be fabricated with a low production cost which is beneficial for mass production.

While the present invention has particularly shown and described with reference to a particular embodiment thereof. It will be understood by those skilled in the art that various changes in form and detail may be effected therein without departing from the spirit and scope of the invention as defined by the appended claims.

What is claimed is:

1. Hydraulic buoyant force engine being characterized in that:
several expansion floats secured between two transmission chains at two outersides of a track assembly is able to circulate between a pair of circulation railways each of them is engaged to one side of said assembly, the air gates of all said expansion floats are linked together with a holes so that all of them can be communicated with one another, said track assembly is composed of two gourd shaped track ways forming in a V shaped structure, when said track assembly is immersed in the water contained in a water tank, said hose interconnecting the air gates of said expansion floats is emerged out of the water level so that the expansion float comes to the widely apart portion between said two track ways is expanded by ingress of the air so as to produce buoyancy causing it to float upward along circulation railways of said track assembly and activate motion of said chains together with output shafts, when said expanded float comes to the narrowly apart portion between the two track ways, it is squeezed to release the air inside and sinks downwards accompanying with the movement of said chains due to loosing of its buoyancy, in this way said chains keep continuous circulation at both sides of said track assembly and the mechanical power is outputted from said output shafts.

2. Hydraulic buoyant engine comprising:
several expansion floats each of the being provided an air gate at one side, and conjoined to a slide arm at its front and rear sides thereof, the right and left ends of each said float is embraced by a hoop respectively which is protectively secured to the slide arm of a supporting stand, each of said two arms are provided with a reel, each said hoop is engaged to a brace provided at its side, several reels are provided on each said brace for engageing with said float, both ends of two guide bars engaged respectively with the front and rear sides of said float body perforate said two braces such that said float can be compressed or expanded between said two guide bars, one of said guide bars is conjoined to a first joint plate with its two ends, while both ends of the other guide bar have a slide block;
a track assembly composed of two track ways forming into V shaped structure;
an air conducting tube provided with an air gate at its proper position thereof, said air conducting tube is perforating near the top portion of said track assembly and emerges its both ends out of said track assembly, a pair of first gear wheels and a pair of second gear wheels are fitted to respective ends of said air conducting tube firmly from outside of said track assembly;
two output shafts each couple with the corresponding one of second sprockets by perforating themselves through bottom portion of said two track ways thereafter two first and said two second sprockets are respectively aligned with each other;
two transmission chains each provided with several support straps, wherein said two chains are coupled with respective corresponding pair of first and second sprockets;
with this structure, by fixing said joint plates to both sides of said float body and respectively engaging to said support straps of said chains and set said two slide blocks in said two circulation railways between said two track ways, all the air gates of said floats disposed therebetween are connected together with a hose, and the output terminal of said hose is connected to the air gate of said air conducting tube such that the air can freely flow into or discharge from said floats via said air conducting tube, said two track ways are laid between the first and second reels respectively provided for said braces at both sides of said expansion floats so as to let said expansion floats circulate along said track ways, when said track assembly is set in a water tank and said air conducting tube is emerged out of the water level, said expansion float in the water located at the widely apart portion between said track ways is expanded to let the air in via said air conducting tube so as to build up a buoyant force able to overcome its own weight and floats up, at this moment, being activated by the buoyant force of said expansion float, said two transmission chains start circulation which in turn activate other expansion floats, said first and second sprockets, said air conducting tube, and said output shafts to operate, as soon as said expanded float has passed over the top portion of said track assembly and come down to the narrowly apart portion between said track ways, said expansed float is squeezed between said first and second guide bars to release the air contained inside, the flattened float now sinks down in the water together with said transmission chains by its own weight, each said expansion float carries out this motion one after another along said track assembly and said transmission chains continue to drive said output shafts thereby useful machencial power is produced.

3. The hydraulic buoyant force engine of claim 1, wherein said expansion float body is made of a steel wire reinforced coiled spring covered with a canvas so as to assure watertight effect and expansibity of said float body.

4. The hydraulic buoyant force engine of claim 2, wherein said expansion float body is banded with three hoops respectively around the central, right and left portions of said float body so as to enhance its strength.

5. The hydraulic buoyant force engine of claims 1 and 4, wherein said two guide bars engaged respectively with the front and the rear sides of said float body are hollow and their inner surfaces are threaded, the central portions of said two guide bars are respectively engaged with two sides of said central hoop so that said two guide bars are engaged respectively with the front and the rear sides of said float body, said two joint plates and said two slide blocks are screw engaged to two ends of said two guide bars.

6. The hydraulic buoyant force engine of claim 2, wherein said track assembly is provided with a framework for securing to a water tank, and welding said circulation railways thereon.

7. The hydraulic buoyant force engine of claim 2, wherein one of said expansion floats has a four way coupling jointed to its air gate, while the rest of said floats are each provided with a three way coupling thereof such that all the air gates are linked together with a hose so that all said expansion floats can be communicated with one another, finally the output terminal of said hose is connected to said air conducting tube via said four way coupling.

8. The hydraulic buoyant force engine of claim 2, wherein a stopper is provided at one end of each said hoop, while the other end thereof is hooked on a hook, said hook is engaged to a hasp on which a tapped hole is formed to be fitted to said stopper so as to tie up said hasp with said stopper by pressing down said hook, therefore, said hook can embrace said expansion float firmly.
